(19) United States
(12) Patent Application Publication
(10) Pub. No.: US 2008/0232226 A1
(43) Pub. Date: Sep. 25, 2008

(54) Information Recording Apparatus and Method, and Computer Program

(75) Inventors: Masahiro Kato, Saitama (JP); Shoji Taniguchi, Saitama (JP); Eiji Muramatsu, Saitama (JP); Toshio Suzuki, Saitama (JP); Kazuo Kuroda, Saitama (JP); Kunihiko Horikawa, Saitama (JP)

Correspondence Address: YOUNG & THOMPSON, 209 Madison Street, Suite 500, ALEXANDRIA, VA, 22314, US

(73) Assignee: PIONEER CORPORATION, Tokyo (JP)

(21) Appl. No.: 10/586,488

(22) PCT Filed: Dec. 8, 2004
(86) PCT No.: PCT/JP2004/018254

§ 371 Date: Jul. 20, 2006

(30) Foreign Application Priority Data
Jan. 23, 2004 (JP) 2004-016247

(51) Int. Cl. G11B 7/00

(52) U.S. Cl. 369/116

(57) ABSTRACT

An information recording apparatus has: a recording device for recording information onto an information recording medium, whose recording speed can be changed to first and second linear velocities, by irradiating laser light with a variable recording power; a measuring device for measuring reproduction quality by reproducing the record information recorded at the first linear velocity, if the recording speed is changed from the first linear velocity to the second linear velocity; a first calculating device for calculating a link power which is the recording power which gives the reproduction quality measured by the measuring device in the second linear velocity, on the basis of correlation information for representing a correlation between the recording power in the second linear velocity and the reproduction quality of the record information; and an adjusting device for adjusting the recording power at a time in stages or in continuity.

### TECHNICAL FIELD

The present invention relates to an information recording apparatus, such as a DVD recorder, an information recording method, and a computer program which makes a computer function as the information recording apparatus.

### BACKGROUND ART

In an information recording apparatus for recording information onto an information recording medium, such as an optical disc, the optimum power of a recording power is set by an OPC (Optimum Power Control) process, depending on the type of the optical disc, the type of the information recording/reproducing apparatus, recording speed and so on. That is, the calibration for the recording power is performed. By this, it is possible to realize an appropriate recording operation. For example, if the optical disc is loaded and a writing command is inputted, data for test writing is recorded into a power calibration area, with sequentially changing the light intensity, so that a so-called test writing process is performed. Then, the data for test writing recorded in this manner is reproduced, and this reproduction result is judged by a predetermined estimation standard, to thereby set the optimum power. Moreover, on an information recording apparatus disclosed in a patent document 1, the recording power obtained by the OPC is adjusted on the basis of reproduction quality which is obtained by the reproduction of actually recorded data.
Patent document 1: Japanese Patent Application Laying Open NO. 2001-297439

### DISCLOSURE OF INVENTION

### Object to be Solved by the Invention

However, in the above-mentioned OPC, the calibration of the recording power is performed in the power calibration area which is set in advance on the optical disc. The power calibration area is generally disposed on the most inner circumferential side or the most outer circumferential side on the optical disc, for example. On the other hand, in the optical disc or the like, recording characteristics in a recording surface are not always uniform, because of a difference in the production condition and the production method thereof. Moreover, it is known that even the temperature characteristics or the like of recording laser likely cause the recording power to be changed. Therefore, there is such a technical problem that even if the calibration of the recording power is performed in the power calibration area, the optimum recording power obtained there is not always appropriate throughout the entire optical disc.

In particular, it is known that even in the case in which the data is recorded into recording areas with difference recording linear velocities, the optimum recording power varies in each of the recording areas. In this case, generally, the optimum recording power for a relatively fast linear velocity is obtained in the calibration area on the substantially outer circumferential side, and the optimum recording power for a relatively slow linear velocity is obtained in the calibration area on the substantially inner circumferential side. However, as described above, because the recording characteristics in the recording surface are not always uniform, there is such a technical problem that it is hardly possible to obtain appropriate reproduction quality before or after the change of the linear velocity. Moreover, there is also such a technical problem that the reproduction quality is likely deteriorated if the recording power is suddenly changed in the recording area in which the recording linear velocity changes. Even if the reproduction quality does not deteriorate, since the reproduction quality changes rapidly at a point where the recording speed changes, there is such a technical problem that it may have an adverse effect on the subsequent reproduction of the record information. Moreover, in the above-mentioned patent document 1, there is also such a technical problem that it is difficult or impossible to adjust the recording power in a recording area where the data is not recorded or in a recording area where the data is about to be recorded, because it is necessary to record the data into a target recording area in order to adjust the recording power.

In order to solve the above-mentioned conventional problem, it is therefore an object of the present invention to provide an information recording apparatus and an information recording method, which enable information to be recorded with an appropriate recording power onto an information recording medium, such as an optical disc, as well as a computer program which makes a computer function as the information recording apparatus.

### Means for Solving the Object

The above object of the present invention can be achieved by an information recording apparatus provided with: a recording device for recording record information onto an information recording medium, in which a recording speed can be changed to at least first and second linear velocities and which supports the first and second linear velocities, by irradiating laser light with a variable recording power; a measuring device for measuring reproduction quality of the record information by reproducing the record information recorded at the first linear velocity, if the recording speed is changed from the first linear velocity to the second linear velocity; a first calculating device for calculating a link power which is the recording power which gives the reproduction quality measured by the measuring device in the second linear velocity, on the basis of correlation information for representing a correlation between the recording power in the second linear velocity and the reproduction quality related to the record information; and an adjusting device for adjusting the recording power, by a predetermined adjustment amount at a time in stages or in a predetermined change rate in continuity, such that the recording power changes from the link power to a reference power which is the recording power which gives desired target quality as the reproduction quality, if the recording speed is changed from the first linear velocity to the second linear velocity.

The above object of the present invention can be also achieved by an information recording method in an information recording apparatus provided with: a recording device of recording record information onto an information recording medium, in which a recording speed can be changed to at least first and second linear velocities and which supports the first and second linear velocities, by irradiating laser light with a variable recording power, the information recording method provided with a measuring process of measuring reproduction quality of the record information by reproducing the record information recorded at the first linear velocity, if the recording speed is changed from the first linear velocity to the second linear velocity; a first calculating process of calculating a link power which is the recording power which gives the reproduction quality measured at the measuring process in the second linear velocity, on the basis of correlation information for representing a correlation between the recording power in the second linear velocity and the reproduction quality related to the record information; and an adjusting process of adjusting the recording power, by a predetermined adjustment amount at a time in stages or in a predetermined change rate in continuity such that the recording power changes from the link power to a reference power which is the recording power which gives desired target quality as the reproduction quality, if the recording speed is changed from the first linear velocity to the second linear velocity.

The above object of the present invention can be also achieved by a computer program for record control to control a computer provided in the information recording apparatus according to claim 1, to make the computer function as at least one portion of the first calculating device, the measuring device and the adjusting device.

These effects and other advantages of the present invention become more apparent from the following embodiments and example.

### BRIEF DESCRIPTION OF DRAWINGS

FIG. 1 shows the basic structure of an optical disc as being one example of the information recording medium which is used for an example of the information recording apparatus of the present invention, wherein the upper part is a substantial plan view showing the optical disc having a plurality of areas.

FIG. 2 is a plan view conceptually explaining an optical disc corresponding to a CLV (Constant Linear Velocity), out of the optical disc used in the information recording apparatus in the example.

FIG. 3 is a block diagram conceptually showing the basic structure of the example of the information recording apparatus of the present invention.

FIG. 4 is a flowchart showing a flow of an operation before data recording in the information recording apparatus in the example.

FIG. 5 is a flowchart showing a flow of an operation related to preparation of a correlation equation between a recording laser power and asymmetry in the information recording apparatus in the example.

FIG. 6 are a graph showing the correlation equation prepared in the information recording apparatus in the example and a list showing specific numeral values of the recording power and the asymmetry which are a basis of the preparation.

FIG. 7 is a flowchart showing a flow of the entire recording operation in the information recording apparatus in the example.

FIG. 8 is a flowchart conceptually showing a flow of an operation of adjusting the recording laser power in the information recording apparatus in the example.

FIG. 9 is a graph conceptually showing a state on the correlation equation upon the adjustment of the recording laser power in the information recording apparatus in the example.

FIG. 10 are explanatory diagrams conceptually showing a state of the asymmetry before and after the change of a linear velocity and a state of the asymmetry in a comparison example, in the information recording apparatus in the example.

### Description of Reference Codes

1 Information recording apparatus
100 Optical disc
104 Lead-in area
106 Data recording area
108 Lead-out area
310 Optical pickup
312 RF detector
315 Servo unit
320 LD driver
330 Envelope detector
340 OPC pattern generator
400 CPU
401 Memory

### BEST MODE FOR CARRYING OUT THE INVENTION

Hereinafter, an explanation will be sequentially given to an information recording medium, an information recording apparatus, an information recording method, and a computer program according to embodiments of the present invention, as being a best mode for carrying out the invention.

### (Embodiment of Information Recording Apparatus)

An embodiment of the information recording apparatus in the present invention is provided with: a recording device for recording record information onto an information recording medium, in which a recording speed can be changed to at least first and second linear velocities and which supports the first and second linear velocities, by irradiating laser light with a variable recording power; a measuring device for measuring reproduction quality of the record information by reproducing the record information recorded at the first linear velocity, if the recording speed is changed from the first linear velocity to the second linear velocity; a first calculating device for calculating a link power which is the recording power which gives the reproduction quality measured by the measuring device in the second linear velocity, on the basis of correlation information for representing a correlation between the recording power in the second linear velocity and the reproduction quality related to the record information; and an adjusting device for adjusting the recording power, by a predetermined adjustment amount at a time in stages or in a predetermined change rate in continuity, such that the recording power changes from the link power to a reference power which is the recording power which gives desired target quality as the reproduction quality, if the recording speed is changed from the first linear velocity to the second linear velocity.

According to the embodiment of the information recording apparatus in the present invention, it is possible to record various record information by the operation of the recording device. Then, it is possible to record the various record information at the first and second linear velocities (i.e. at a recording speed corresponding to the first linear velocity and a recording speed corresponding to the second linear velocity) onto the information recording medium which supports both the first and second linear velocities.

Particularly in the embodiment, in the case in which the recording speed is changed from the first linear velocity to the second linear velocity, it is possible to perform the appropriate recording operation. Specifically, in the case in which the recording speed is changed, the reproduction quality of the record information recorded at the first linear velocity is measured by the operation of the measuring device. At this time, as described later, it is preferable to measure the reproduction quality of the record information recorded last at the first linear velocity. Then, by the operation of the first calculating device, the link power which corresponds to the recording power which realizes this reproduction quality in the second linear velocity is calculated. The calculation of the link power is performed on the basis of the correlation information which indicates the correlation between the recording power in the second linear velocity and the reproduction quality of the record information recorded at this recording power. Then, by the operation of the adjusting device, the recording power is adjusted such that the recording power smoothly changes from the link power to the reference power after the recording speed is changed to the second linear velocity. The reference power corresponds to the recording power which realizes the desired target quality in the second linear velocity as the reproduction quality. The recording power is changed by the predetermined adjustment amount at a time in stages or in the predetermined change rate in continuity, to thereby realize a smooth change (i.e. soft landing described later) in the recording power.

By this, even in the case in which the recording speed is changed, the reproduction quality of the record information to be recorded is not rapidly changed, and it is possible to smoothly change the reproduction quality from the reproduction quality in the first linear velocity (e.g. the desired target quality in the first linear velocity) to the reproduction quality in the second linear velocity (e.g. the desired target quality in the second linear velocity). Therefore, even when the record information is reproduced, the situation in which the reproduction quality is rapidly changed at a point where the recording speed is changed with the operation of an information recording apparatus hardly occurs, for example. In other words, since the record information can be recorded appropriately (i.e. without a rapid change in the reproduction quality) even at the point where the recording speed is changed, it is possible to appropriately reproduce the record information as a result.

Particularly in the embodiment, when the link power is calculated, the correlation information which indicates the correlation between the recording power and the reproduction quality is used. Thus, it is possible to relatively easily calculate the link power which corresponds to or is suitable for an actual recording state. In other words, it can be said that the present invention has a more excellent effect than the invention described in the patent document 1 or the like, for example, in the point that recording power can be adjusted on the basis of a tendency in the change of the recording power indicated by the correlation information. The operation of adjusting the recording power on the basis of the correlation information will be explained in more detail in Example described later.

Consequently, according to the embodiment of the information recording apparatus of the present invention, by effectively using the correlation information, it is possible to realize the appropriate recording operation without a rapid change in the reproduction quality of the record information, even if the recording speed is changed. Therefore, it is possible to record the record information with the appropriate recording power, and as a result, upon the reproduction of the record information, it is possible to prevent the occurrence of a reproduction error. Thus, the reproduction quality can be more improved.

In one aspect of the embodiment of the information recording apparatus in the present invention, the measuring device measures the reproduction quality by reproducing the record information recorded immediately before the recording speed is changed from the first linear velocity to the second linear velocity.

According to this aspect, by comparison with the reproduction quality of the record information recorded immediately before the measurement (i.e. immediately before the linear velocity is changed), it is possible to obtain a more preferable link power. Here, the term “immediately before” in the present invention is a wide concept not only indicating a literal meaning of “immediately before” but also including a situation which can be equated with “immediately before” even after a certain degree of period elapses. Therefore, even if the linear velocity is changed, it is possible to record the record information, more preferably.

In another aspect of the embodiment of the information recording apparatus in the present invention, the predetermined adjustment amount or the predetermined change rate is variable.

By such construction, it is possible to set the degree of the change of the recording power, as occasion demands. For example, if the predetermined adjustment amount or the predetermined change rate is set to be relatively small, it is possible to make the change of the recording power relatively mild. On the other hand, if the predetermined adjustment amount or the predetermined change rate is set to be relatively large, it is possible to make the change of the recording power relatively rapid or sudden.

In another aspect of the embodiment of the information recording apparatus in the present invention, the adjusting device adjusts the recording power such that the recording power changes to the reference power if a difference between the link power and the reference power is equal to or less than a predetermined amount.

According to this aspect, if the difference between the link power and the reference power is equal to or less than the predetermined amount, the recording power is adjusted straight to the reference power without stepwise or continuous adjustment. On the other hand, if the difference between the link power and the reference power is equal to or greater than the predetermined amount, the recording power is adjusted such that the recording power changes from the link power to the reference power in stages or in continuity. Therefore, since it is unnecessary to needlessly perform the stepwise or continuous adjustment of the recording power, it is possible to improve the process performance of the recording operation.

In another aspect of the embodiment of the information recording apparatus in the present invention, it is further provided with a second calculating device for preparing the correlation information and for calculating the reference power, by reproducing test information which is the record information recorded for test by the recording device while the recording power is changed.

According to this aspect, it is possible to appropriately obtain the link power and perform the adjustment operation of the recording power, by using the correlation information prepared by the operation of the second calculating device and the reference power calculated by the operation of the second calculating device.

In another aspect of the embodiment of the information recording apparatus in the present invention, the reproduction quality includes at least one of an asymmetry value, a jitter value, and a reproduction error rate.

According to this aspect, by obtaining the reference power and the link power or the like with combining the reproduction qualities as occasion demands, it is possible to appropriately adjust a setting value so as to realize the more appropriate recording operation.

In another aspect of the embodiment of the information recording apparatus in the present invention, it is further provided with a controlling device for controlling the recording device to record at least one of the correlation information prepared by the second calculating device and information as for the reference power calculated by the second calculating device, onto the information recording medium.

According to this aspect, there is such a great advantage that by recording the above information onto the information recording medium, it is possible to obtain the appropriate adjustment amount not only on the information recording apparatus which prepares and calculates the reference power and the correlation information, but also on another information recording apparatus (e.g. an information recording apparatus which has not recorded the record information onto the information recording medium, or the like) by referring to the correlation information or the like recorded on the information recording medium.

### (Embodiment of Information Recording Method)

An embodiment of the information recording method in the present invention is an information recording method in an information recording apparatus provided with: a recording device for recording record information onto an information recording medium, in which a recording speed can be changed to at least first and second linear velocities and which supports the first and second linear velocities, by irradiating laser light with a variable recording power, the information recording method provided with: a measuring process of measuring reproduction quality of the record information by reproducing the record information recorded at the first linear velocity, if the recording speed is changed from the first linear velocity to the second linear velocity; a first calculating process of calculating a link power which is the recording power which gives the reproduction quality measured at the measuring process in the second linear velocity, on the basis of correlation information for representing a correlation between the recording power in the second linear velocity and the reproduction quality related to the record information; and an adjusting process of adjusting the recording power, by a predetermined adjustment amount at a time in stages or in a predetermined change rate in continuity such that the recording power changes from the link power to a reference power which is the recording power which gives desired target quality as the reproduction quality, if the recording speed is changed from the first linear velocity to the second linear velocity.

According to the embodiment of the information recording method in the present invention, it is possible to receive the same various benefits as those of the above-mentioned embodiment of the information recording apparatus in the present invention.

Incidentally, in response to the various aspects of the above-mentioned embodiment of the information recording apparatus in the present invention, the embodiment of the information recording method in the present invention can also adopt various aspects.

### (Embodiment of Computer Program)

An embodiment of the computer program in the present invention makes a computer function as the above-mentioned embodiment of the information recording apparatus (including its various aspects). More specifically, it makes the computer function as at least one portion of the first calculating device, the measuring device, and the adjusting device.

According to the embodiment of the computer program in the present invention, the above-mentioned embodiment of the information recording apparatus in the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the various aspects of the above-mentioned embodiment of the information recording apparatus in the present invention, the embodiment of the computer program in the present invention can also adopt various aspects.

The above object of the present invention can be also achieved by an embodiment of a computer program product in a computer-readable medium for tangibly embodying a program of instructions executable by a computer, to make the computer function as the above-mentioned embodiment of the information recording apparatus of the present invention (including its various aspects). More specifically, it makes the computer function as at least one portion of the first calculating device, the measuring device, and the adjusting device.

According to the embodiment of the computer program product of the present invention, at least one portion of the recording device, the first calculating device, the measuring device, and the adjusting device of the present invention can be embodied relatively readily, by loading the computer program product from a recording medium for storing the computer program product, such as a ROM (Read Only Memory), a CD-ROM (Compact Disc—Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as at least one portion of the recording device, the first calculating device, the measuring device, and the adjusting device of the present invention.

Incidentally, in response to the various aspects of the above-mentioned embodiment of the information recording apparatus in the present invention, the embodiment of the computer program product in the present invention can also adopt various aspects.

These effects and other advantages of the present invention become more apparent from the following example.

As explained above, according to the embodiment of the information recording apparatus in the present invention, it is provided with: the recording device; the first calculating device; the measuring device; and the adjusting device. Therefore, even if the linear velocity is changed, it is possible to record the record information at the appropriate recording power, and as a result, even upon the reproduction, it is possible to reproduce the information, appropriately.

### EXAMPLE

Hereinafter, an example of the present invention will be discussed with reference to the drawings.

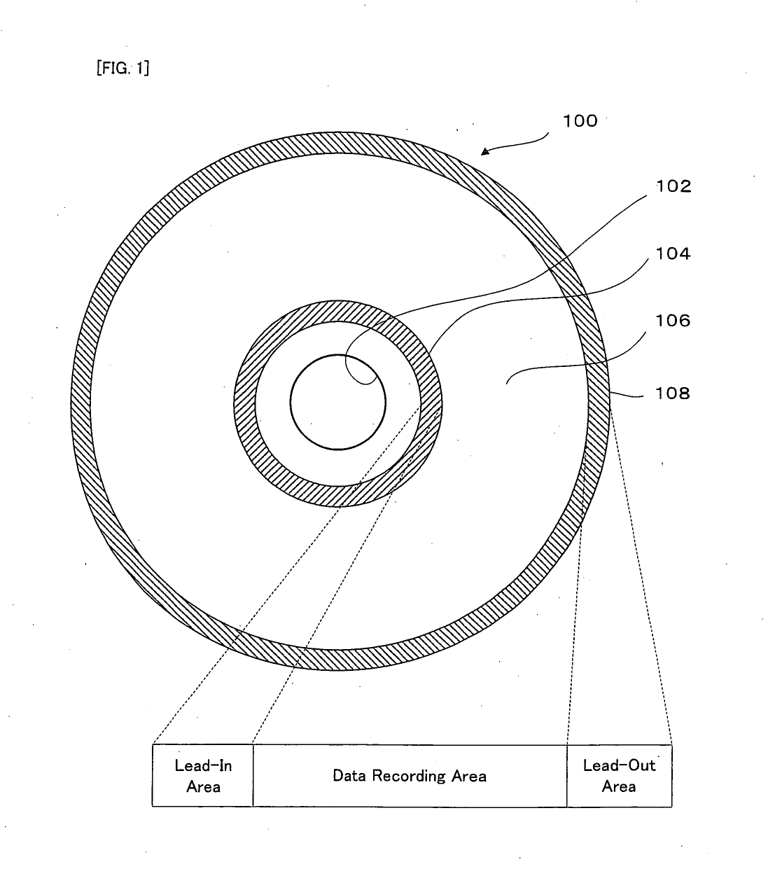

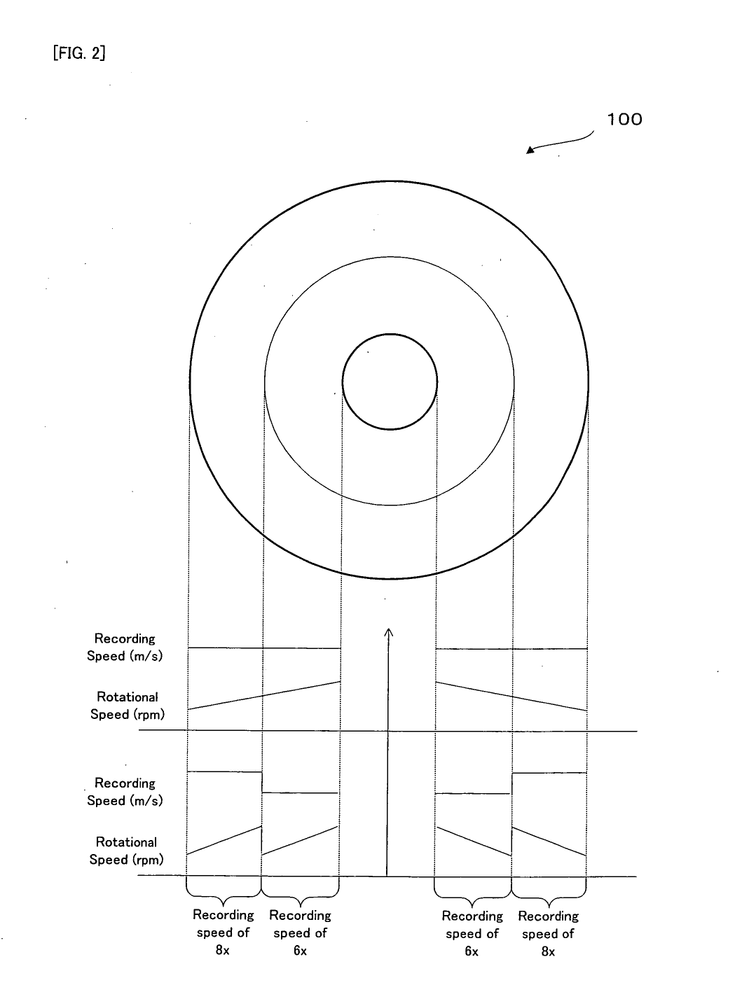

At first, with reference to FIG. 1 and FIG. 2, an information recording medium used in an example of the information recording apparatus of the present invention will be discussed. In this example, an optical disc of a recording type is used for explanation as the information recording medium. FIG. 1 shows the structure of the optical disc having a plurality of areas in a substantial plan view on the upper part, and correspondingly shows an area structure in the radial direction in a conceptual view on the lower side. FIG. 2 is a plan view conceptually explaining an optical disc which supports a CLV

### (Constant Linear Velocity).

As shown in FIG. 1, on an optical disc 100, recording (writing) can be performed a plurality of times or once, in various recording methods, such as a magneto optical method and a phase change method. The optical disc 100 has a recording surface on a disc main body with a diameter of about 12 cm, as is a DVD. On the recording surface, the optical disc 100 is provided with: a lead-in area 104; a data recording area 106; and a lead-out area 108, from the inner circumference to the outer circumference, with a center hole 102 as the center. Then, in each recording area, groove tracks and land tracks are alternately provided, spirally or concentrically, with the center hole 102 as the center. The groove tracks may be wobbled, or pre-pits may be formed on one of or both of the tracks. Incidentally, the present invention is not particularly limited to the optical disc having these three areas. For example, even if the lead-in area 104 or the lead-out area 108 does not exist, a file structure explained below can be constructed. Moreover, as described later, the lead-in area 104 and the lead-out area 108 may be further segmentized.

In the example, as shown in FIG. 2, the optical disc 100 in a CLV method corresponding to a plurality of recording speeds is used. In other words, on the relatively inner circumferential side of the optical disc 100, the rotation speed of the optical disc 100 is controlled to realize a recording speed of 6×. On the other hand, on the relatively outer circumferential side of the optical disc 100, the rotation speed of the optical disc 100 is controlled to realize a recording speed of 8×. In the case in which the linear velocity is made constant in the disc surface, it is required to rotate the optical disc at a relatively high rotation speed on the inner circumferential side. However, as in the recording speed of 8×, at the recording speed that a relatively large rotation speed is already required, there is a possibility that it is impossible to realize a desired rotation speed on the inner circumferential side, because of a limit on the standard of a spindle motor. Therefore, in order to solve this problem, the data is recorded at the recording speed of 6× that a relatively low rotation speed suffices, on the inner circumferential side, and the data is recorded at the recording speed of 8× that a relatively high rotation speed is required, on the outer circumferential side. This recording method is generally referred to as a ZCLV (Zone CLV) method.

Incidentally, the term “6×” and “8×” or the like used in the example indicate “6 times speed” and “8 times speed”, respectively. In other words, the term “nx (n is an integer equal to or greater than 1) indicates “n times speed”. For example, if the linear velocity upon the recording at a recording speed of 1 time speed is 3.49 m/s, then, upon the recording at the recording speed of 6 times speed, the linear velocity is substantially 3.49×6=20.94 m/s. Alternatively, upon the recording at the recording speed of 8 times speed, the linear velocity is substantially 3.49×8=27.92 m/s.

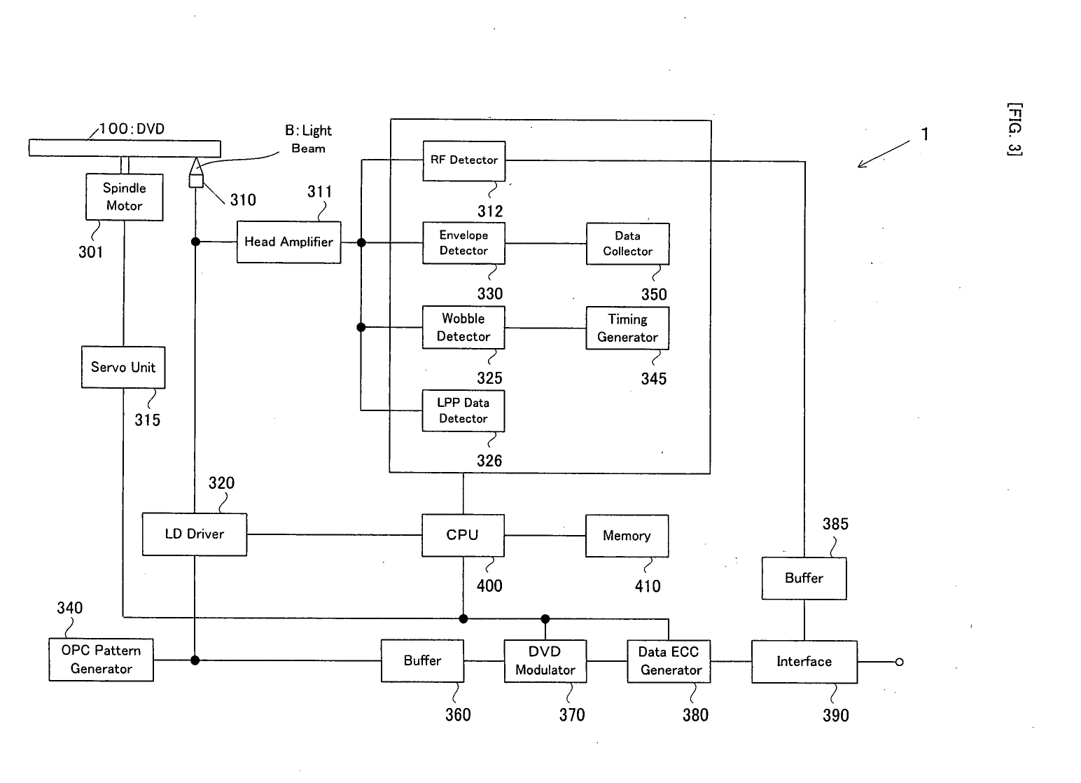

Next, with reference to FIG. 3 to FIGS. 10, the example of the information recording apparatus in the present invention will be discussed.

### (Basic Structure)

At first, with reference to FIG. 3, the basic structure of the information recording apparatus in the example will be discussed. FIG. 3 is a block diagram conceptually showing the basic structure of the information recording apparatus in the example.

As shown in FIG. 3, an information recording apparatus 1 in the example is provided with: a spindle motor 301; an optical pickup 310; a head amplifier 311; a RF detector 312; a servo unit 315; an LD driver 320; a wobble detector 325; a LPP data detector 326; an envelope detector 330; an OPC pattern generator 340; a timing generator 345; a data collector 350; a buffer 360; a DVD modulator 370; a data ECC generator 380; a buffer 385; an interface 390; a CPU 400; and a memory 410.

The spindle motor 301 is constructed to rotate the optical disc 100 at a predetermined speed under spindle servo from the servo unit 315 or the like.

The optical pickup 310 is one specific example of the “recording device” of the present invention. The optical pickup 310 is intended to perform the recording/reproduction with respect to the optical disc 100, and is provided with a semiconductor laser device, various lenses, an actuator and the like. More specifically, the optical pickup 310 irradiates the optical disc 100 with a light beam, such as laser light, as reading light with a first power upon reproduction, and as writing light with a second power upon recording, with it modulated. The optical pickup 310 is constructed to be displaced in the radial direction or the like of the optical disc 100, by a not-illustrated actuator, slider, or the like, which is driven by the servo unit 315.

The head amplifier 311 amplifies the output signal (i.e. the reflected light of a light beam B) of the optical pickup 310, and outputs the amplified signal. Specifically, a RF signal as being a reading signal is outputted to the RF detector 312 and the envelope detector 330, and a push-pull signal is outputted to the wobble detector 325 and the LPP data detector 326.

The RF detector 312 is constructed to detect the RF signal and perform demodulation or the like, to thereby output the reproduction data to the exterior through the buffer 385 and the interface 390. Then, on external output equipment (e.g. a display device, such as a liquid crystal display and a plasma display, a speaker, or the like) connected to the interface 390, a predetermined content is reproduced and outputted.

The servo unit 315 displaces the objective lens of the optical pickup 310, on the basis of a tracking error signal and a focus error signal or the like, which are obtained by processing the light receiving result of the optical pickup 310, to thereby perform various servo processes, such as tracking control and focus control. Moreover, the servo unit 315 is constructed to servo-control the spindle motor 301, on the basis of a wobble signal obtained from the wobble of the wobbled groove tracks on the optical disc 100.

The LD driver 320 drives the semiconductor laser disposed in the optical pickup 310, in order to determine a reference recording laser power in the recording and reproduction processes of an OPC pattern described later, upon an OPC process described later. After that, the LD driver 320 drives the semiconductor laser of the optical pickup 310 with the optimum recording laser power determined by the OPC process, upon the data recording. Upon the data recording, the recording laser power is modulated in accordance with the record data.

The wobble detector 325 is constructed to detect a push-pull signal which indicates the wobble signal, on the basis of the output signal corresponding to the amount of the received light from the head amplifier 311, which is a detector, disposed in the optical pickup 310, for receiving a reflected light beam, and to output it to the timing generator 345.

The LPP data detector 326 is constructed to detect a push-pull signal which indicates an LPP signal, on the basis of the output signal corresponding to the amount of the received light from the head amplifier 311, which is a detector, disposed in the optical pickup 310, for receiving a reflected light beam, and to detect pre-format address information, for example, as described later. Then, the LPP data detector 326 is constructed to output the pre-format address information to the timing generator 345.

The envelope detector 330 is constructed to detect the peak value and the bottom value of envelope detection of the RF signal as being the output signal from the head amplifier 311, in order to determine the reference recording laser power, under the control of the CPU 400, upon the reproduction of the OPC pattern in the OPC process. The envelope detector 330 may include an A/D (Analog/Digital) converter or the like, for example.

The OPC pattern generator 340 is constructed to output a signal which indicates the OPC pattern to the LD driver 320, on the basis of a timing signal from the timing generator 345, upon the recording of the OPC patter in the OPC process before the recording operation.

The timing generator 345 detects absolute position information based on the management unit of the pre-format address information, on the basis of the pre-format address information inputted by the LPP data detector 326, upon the recording of the OPC pattern in the OPC process. Simultaneously, the timing generator 345 detects relative position information based on a slot unit (e.g. a slot unit corresponding to a length which is a natural number multiple of one cycle of the wobble signal) which is smaller than the management unit of the pre-format address information, on the basis of the cycle of the push-pull signal which indicates the wobble signal. Thus, whether or not a recording start position in the OPC process starts from the boundary of the management unit of the pre-format address information, the timing generator 345 can specify the recording start position. After that, the timing generator 345 generates and outputs a timing signal for writing the OPC pattern, on the basis of the cycle of the push-pull signal which indicates the wobble signal outputted from the wobble detector 345. On the other hand, the timing generator 345 can specify a reproduction start position, upon the reproduction of the OPC pattern in the OPC process, as in the recording. After that, the timing generator 345 generates and outputs a timing signal for sampling the reproduced OPC pattern, on the basis of the cycle of the push-pull signal which indicates the wobble signal outputted from the wobble detector 345.

The data collector 350 is mainly a memory in general. For example, it is provided with an external RAM or the like. An envelope detected by the envelope detector 330 is stored into the data collector 350, and on the basis of this, the detection of an optimum recording laser power on the CPU 400, i.e., the OPC process, is performed.

The buffer 360 is constructed to store therein the record data modulated by the DVD modulator 370 and output it to the LD driver 320.

The DVD modulator 370 is constructed to perform DVD modulation with respect to the record data, and output it to the buffer 360. As the DVD modulation, for example, 8-16 modulation and RLL (Run Length Limiter) modulation may be performed.

The data ECC generator 380 appends or adds a code for error correction to the record data which is inputted from the interface 390. Specifically, the data ECC generator 380 appends an ECC code in each predetermined block unit (e.g. ECC block unit), and outputs it to the DVD modulator 370.

The buffer 385 stores therein the reproduction data outputted from the RF detector 312, and outputs it to the external output equipment through the interface 390.

The interface 390 receives the input of the record data or the like from external input equipment, and outputs it to the data ECC generator 380. Moreover, it may be constructed to output the reproduction data outputted from the RF detector 312, to the external output equipment, such as a speaker and a display.

The CPU 400 controls the information recording apparatus 1 as a whole, by giving an instruction, i.e. by outputting a system command, to each device, such as the LD driver 320 and the servo unit 315, in order to detect the optimum recording laser power. Normally, software for operating the CPU 400 is stored in an internal or external memory.

The memory 410 includes a semiconductor memory, such as a RAM and a flush memory, and is constructed to record a correlation equation and the value of the recording laser power, as described later.

Incidentally, the information recording apparatus in the example explained with reference to FIG. 3 is also used as the example of an information recording/reproducing apparatus. In other words, it can reproduce the record information through the head amplifier 311 and the RF detector 312, and it includes the function of an information reproducing apparatus or the function of an information recording/reproducing apparatus in the example.

### (Operation Principle)

Next, with reference to FIG. 4 to FIGS. 10, the operation principle of the information recording apparatus 1 in the example will be explained.

### (1) Operation Before Recording

At first, with reference to FIG. 4, the operation of the information recording apparatus 1 in the example before recording various data will be discussed. FIG. 4 is a flowchart showing a flow of the operation before the data recording of the information recording apparatus 1 in the example.

Incidentally, as a specific operation of the information recording apparatus 1 in the example, an explanation will be given to a recording operation in recording the data onto the optical disc 100 in the ZCLV recording method, by changing the recording speed to the recording speed of 6×, as being one specific example of the “first linear velocity” of the present invention, and the recording speed of 8×, as being one specific example of the “second linear velocity” of the present invention, as occasion demands.

In FIG. 4, at first, the optical disc 100 is loaded (step S101). Then, under the control of the CPU 400, a seek operation is performed by the optical pickup 310, and various data for management necessary for the recording process onto the optical disc 100 is obtained. On the basis of the data for management, the data is recorded onto the optical disc 100 through the interface 390, in accordance with an instruction from the external input equipment or the like, by the control of the CPU 400.

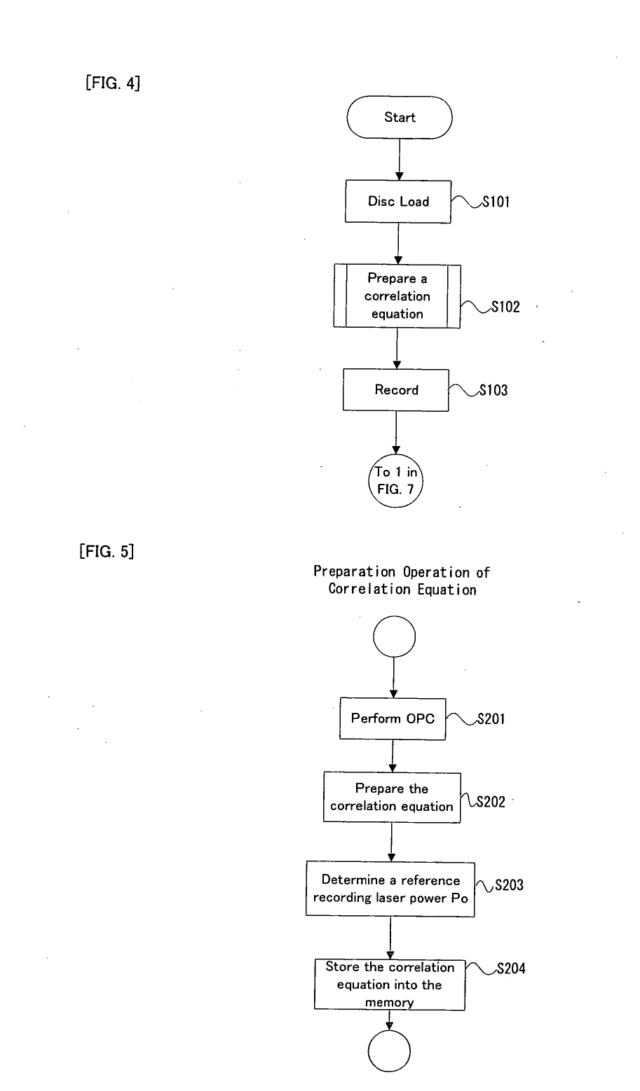

After this loading, under the control of the CPU 400, a correlation equation (specifically, a correlation equation which indicates a relationship between a recording laser power and asymmetry) is prepared, which is one specific example of the “correlation information” of the present invention (step S102). The preparation operation of the correlation equation will be described in detail later (refer to FIG. 5).

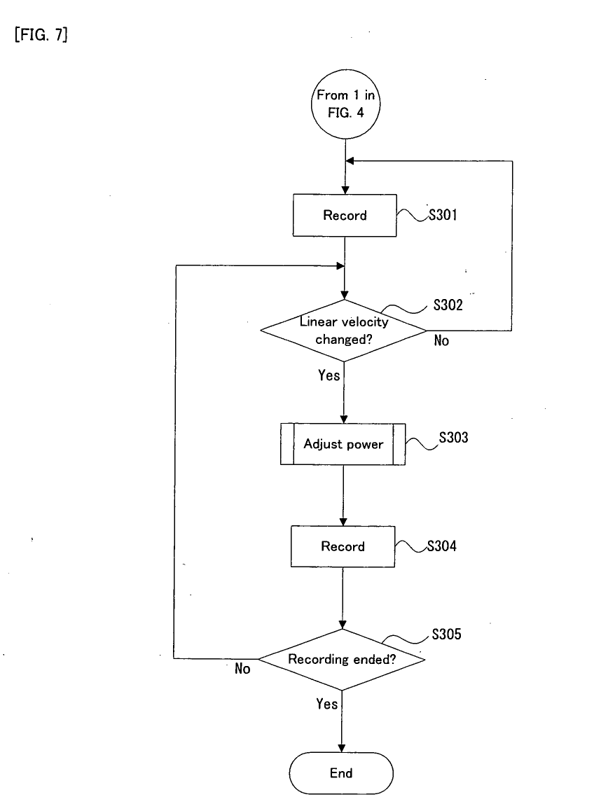

Then, after the preparation of the correlation equation, the recording operation of various content data, such as video data, audio data and data for PC, is performed (step S103). This recording operation will be also described in detail later (refer to FIG. 7 etc.).

Incidentally, if the correlation equation which indicates the relationship between the recording laser power and the asymmetry is already prepared, the preparation operation of the correlation equation in the step S102 is not necessarily performed. For example, if the correlation equation is recorded in the memory 410 of the information recording apparatus 1, it may be used to perform the recording operation described later. Alternatively, if the correlation equation is recorded on the optical disc 100 itself, it may be read to perform the recording operation described later.

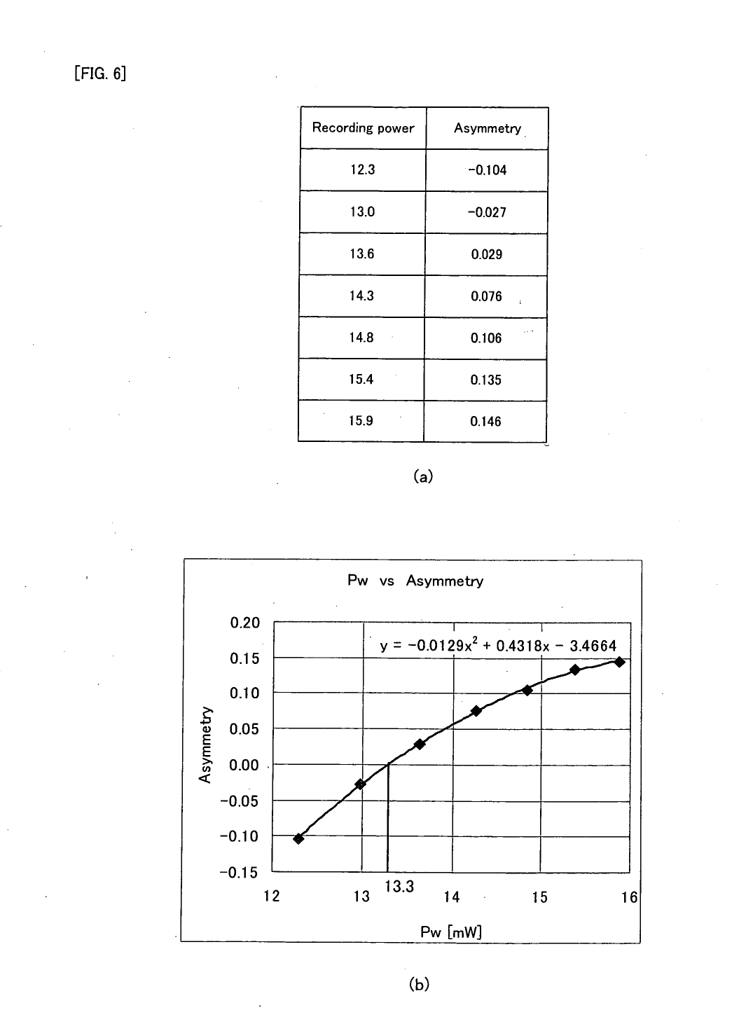

Next, with reference to FIG. 5 and FIGS. 6, the preparation operation of the correlation equation will be explained. FIG. 5 is a flowchart showing a flow of the preparation operation of the correlation equation between the recording laser power and the asymmetry. FIGS. 6 are a graph showing the prepared correlation equation and a list showing specific numeral values of the recording power and the asymmetry which are a basis of the preparation.

As shown in FIG. 5, at first, the OPC process is performed (step S201). Here, the OPC process is explained, more specifically. At first, under the control of the CPU 400, the optical pickup 310 is displaced to a power calibration area disposed in the lead-in area 104 (or the lead-out area 108). Then, by the control of the OPC pattern generator 340 and the LD driver 320 or the like, the recording laser power (e.g. mutually different 16 step recording laser power) is changed sequentially in stages, and the OPC pattern as being one specific example of the “test information” of the present invention is recorded into the power calibration area. As the OPC pattern, a recording pattern in which a short pit corresponding to a 3 T pulse and a long pit corresponding to 11 T pulse are alternately formed with respective non-recording sections, which have the same length as that of the short pulse or the long pulse, is taken as one example.

In this case, in preparing the correlation equation in the recording speed of 6×, it is preferable to record the OPC pattern in the power calibration area disposed in the lead-in area 104 on the inner circumferential side, for example. Then, in this case, the OPC pattern is recorded at the recording speed of 6×. On the other hand, in preparing the correlation equation in the recording speed of 8×, it is preferable to record the OPC pattern in the power calibration area disposed in the lead-out area 108 on the outer circumferential side, for example. Then, in this case, the OPC pattern is recorded at the recording speed of 8×. This is because, as described in FIG. 2, where the data is recorded at the recording speed of 6× is on the relatively inner circumferential side of the optical disc 100, and where the data is recorded at the recording speed of 8× is on the relatively outer circumferential side of the optical disc 100. Moreover, this is also because it is considered to be difficult, in the standard of the spindle motor 301, to rotate the optical disc 100 in order to realize the recording speed of 8× in the power calibration area on the inner circumferential side.

The LD driver 320 drives the semiconductor laser in the optical pickup 310, in order to change the recording laser power sequentially in stages, in accordance with the OPC pattern outputted from the OPC pattern generator 340.

Moreover, after the completion of the recording of the OPC pattern into the power calibration area, the OPC pattern recorded in the power calibration area is reproduced, under the control of the CPU 400. Then, by the RF signal inputted to the envelope detector 330 as being one specific example of the “measuring device” of the present invention, the peak value and the bottom value of the envelope detection of the RF signal are sampled and outputted to the data collector 350. Then, under the control of the CPU 400, the peak value and the bottom value are stored into the data collector 350. Then, the OPC pattern is reproduced, in accordance with the number of times that the OPC pattern is recorded, in one OPC process, and the asymmetry is obtained from the peak value and the bottom value at each time of the reproduction.

Then, the correlation equation is prepared on the basis of the result of the OPC process performed in the step S201 (step S202). In other words, a function which indicates the relationship between the recording laser power changed sequentially in stages and the asymmetry of the OPC pattern recorded with the recording laser power is prepared in the step S202.

For example, the correlation equation in the recording speed of 8× will be specifically explained. It is assumed that the relationship between the recording laser power and the asymmetry shown in FIG. 6(a) is obtained by recording the OPC pattern at the recording speed of 8×. At this time, if the relationship is plotted on a graph with the vertical axis as the asymmetry and the horizontal axis as the value of the recording laser power and the plotted points are joined by an approximate curve, the graph shown in FIG. 6(b) is obtained. The approximate curve can be obtained by using a mathematical or statistical method, such as a least-squares method, for example. Then, if the least-squares method or the like is used, the value of the recording laser power is x, and the value of the asymmetry is y, the relationship shown in FIG. 6(a) is indicated by the correlation equation y=−0.0129×²+0.4318×−3.4664. Of course, it is obvious that the same correlation equation can be prepared by recording the OPC pattern at the recording speed of 6×.

Incidentally, in the example, the correlation equation is prepared by a quadric curve; however, without limit to this, the correlation equation may be prepared by an arbitrary function shown by a cubic curve, a quartic curve, or the like, for example. Moreover, as the correlation equation, without limit to the above-mentioned function, various aspects, such as a list and a table, may be adopted.

In FIG. 5 again, under the control of the CPU 400 as being one specific example of the “second calculating device” of the present invention, a recording laser power which gives a desired asymmetry value (e.g. 0) is obtained as a reference recording laser power Po (i.e. one specific example of the “reference power” of the present invention) (step S203). For example, if the correlation equation as shown in FIG. 6(b) is obtained, a value 13.3 mW of the recording laser power which gives the asymmetry of 0 is obtained, as the reference recording laser power in the recording speed of 8×. Of course, the reference recording laser power in the recording speed of 6× can be also obtained in the same operation.

However, on the standard of a DVD-ROM or the like, for example, the appropriate recording operation or the like can be performed in an asymmetry range of −0.05 to 0.15. Thus, it is not always necessary to set the value of the recording laser power which gives the asymmetry of 0, to the reference recording laser power. For example, other values, such as 0.10 and −0.03, may suffice. However, in order to obtain a better reproduction error rate, it is desirable to make the asymmetry which allows optimum recording characteristics such as jitter. Thus, since the asymmetry value which allows the optimum recording varies in each disc or depending on the recording speed, it is also possible to determine the desired asymmetry value by reading optimum asymmetry information which is recorded in advance in the disc.

Then, the correlation equation prepared in the step S202 (i.e. the correlation equation in each of the recording speeds of 6× and 8×, e.g., the above-mentioned correlation equation y=−0.0129×²+0.4318×−3.4664) is recorded into the memory 410 (step S204). At this time, the reference recording laser power (i.e. the reference laser power in each of the recording speeds of 6× and 8×, e.g., the above-mentioned numerical value of 13.3 mW) is also recorded into the memory 410, simultaneously.

Incidentally, even if they are not recorded into the memory 410, the correlation equation and the value of the recording laser power may be recorded onto the optical disc 100, under the control of the CPU 400 which corresponds to one specific example of the “controlling device” of the present invention, for example. By this, regardless of a difference in the types or the like of the information recording apparatus, or even in the case of the information recording apparatus which records the data onto the optical disc 100 for the first time, it is possible to perform the adjustment operation of the recording laser power by a soft landing operation, as described later.

Moreover, in the above-mentioned example, the OPC pattern is actually recorded at the recording speed of 8×, to thereby calculate the reference recording laser power in the recording speed of 8×. However, the OPC pattern may be actually recorded at the recording speed of 6× (or 4×, etc.) slower than the recoding speed of 8×, and the OPC pattern is reproduced, to thereby predict or estimate the reference recording laser power in the recording speed of 8×. By such construction, for example, even if the power calibration area cannot be provided on the outer circumferential side, the OPC pattern is recorded into the power calibration area disposed on the inner circumferential side, to thereby calculate the reference recording laser power in the recording speed of 8×.

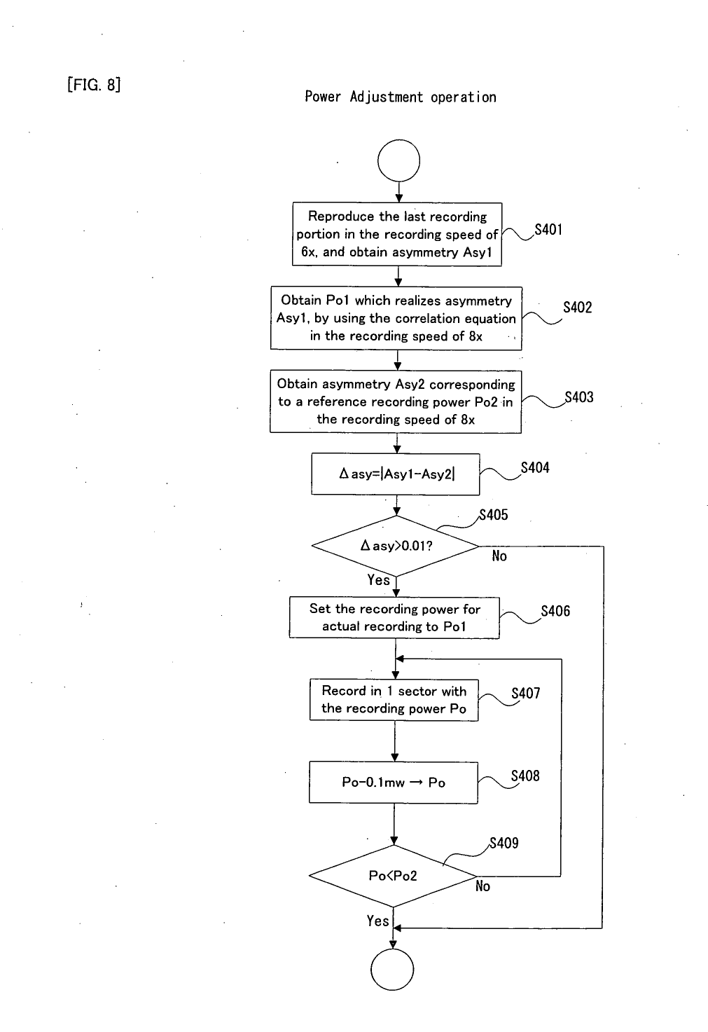

Next, with reference to FIG. 7 and FIG. 8, the operation principle of the actual recording operation of the information recording apparatus 1 in the example will be explained. FIG. 7 is a flowchart conceptually showing a flow of the entire recording operation. FIG. 8 is a flowchart conceptually showing a flow of the adjusting operation of the recording laser power.

As shown in FIG. 7, various data including the content data or the like is actually recorded (step S301). Specifically, the optical pickup 310 is displaced to a recording area (e.g. the data recording area 106 or the like shown in FIG. 1), and the recording area is irradiated with the laser light with the recording laser power obtained in advance (i.e. the reference recording laser power) by the control of the LD driver 320 or the like. For example, if the recording is performed at the recording speed of 6×, the laser light is irradiated with the reference recording laser power in the recording speed of 6×. On the other hand, if the recording is performed at the recording speed of 8×, the laser light is irradiated with the reference recording laser power in the recording speed of 8×. Then, the laser light is modulated in accordance with the record data, to thereby record the record data into the recording area. In other words, a recording pit is formed on the track, in accordance with the record data.

Then, under the control of the CPU 400, it is judged whether or not the linear velocity is changed (step S302). With respect to the judgment here, for example, when the data is recorded at the recording speed of 6×, it is judged whether the recording speed is changed to the recording speed of 8×. Alternatively, when the data is recorded at the recording speed of 8×, it is judged whether the recording speed is changed to the recording speed of 6×. This judgment may be performed on the basis of the number of rotations of the spindle motor 301 or the address value of the recording area which is a recording target of the data. For example, if a boundary between the recording area where the data is recorded at the recording speed of 6× and the recording area where the data is recorded at the recording speed of 8× is determined, whether or not the linear velocity is changed may be judged by reading the pre-format address information on the optical disc. Alternatively, it may be judged that the linear velocity is changed, if the number of rotations of the spindle motor 301 changes greatly.

As a result of the judgment, if it is judged that the linear velocity is not changed (step S302: No), the recording of the data is continued as it is, and it is judged again whether or not the linear velocity is changed.

On the other hand, if it is judged that the linear velocity is changed (step S302: Yes), the recording laser power is adjusted (step S303). The adjustment operation of the recording laser power will be discussed in detail later (refer to FIG. 8). Then, the recording of the data is continued at the recording speed after change (step S304), and further, under the control of the CPU 400, it is judged whether or not the recording operation is ended (step S305). With respect to the judgment here, it is judged whether or not the recording operation of the data is ended in both the recording speeds of 6× and 8×. For example, in the case in which the recording of the data is ended in the recording speed of 8×, in order to record the data at the recording speed of 6× again while the data is recorded at the recording speed of 8×, it is judged that the recording operation is not ended. In other words, this is the judgment of whether or not the recording operation itself is ended.

As a result of the judgment, if it is judged that the recording operation is ended (the step S305: Yes), the recording operation is ended, and the optical disc 100 on which the desired data is recorded is taken out, as needed. At this time, a finalize process may be performed.

On the other hand, if it is judged that the recording operation is not ended (the step S305: No), the operational flow returns to the step S302 again, and it is judged whether or not the linear velocity is changed. Then, after that, the recording of the data is continued while the recording laser power is adjusted every time the linear velocity is changed.

Next, the adjustment operation of the recording laser power in the step S303 in FIG. 7 will be explained in more detail. Here, an explanation is given, as a specific example, to the case in which the recording speed is changed to the recording speed of 8× during the recording operation of the data at the recording speed of 6×.

Incidentally, the information recording apparatus 1 in the example is constructed to perform the soft landing operation at the boundary between the recording operation of the data at the recording speed of 6× and the recording operation of the data at the recording speed of 8×. Here, the soft landing operation indicates such an aspect that when the recording laser power is changed, the value of the recording laser power is changed, gradually or smoothly, by a predetermined adjustment amount at a time or in each predetermined change rate. Specifically, as described later, it indicates such an aspect that the value of the recording laser power is changed by “0.1 mW” at a time, for example, to thereby adjust it to the desired value of the recording laser power in the end.

As shown in FIG. 8, at first, under the control of the CPU 400, the last recording portion (recording area) in the recording speed of 6× is reproduced, and asymmetry Asy1 of the data recorded last at the recording speed of 6× is obtained (step S401).

Then, on the basis of the correlation equation in the recording speed of 8× which is prepared in the step S202 in FIG. 5, under the control of the CPU 400 as being one specific example of the “first calculating device” of the present invention, a recording laser power Po1 is obtained which realizes the asymmetry Asy1 in the recording speed of 8× (step S402). The recording laser power Po1 obtained here corresponds to one specific example of the “link power” of the present invention. Moreover, asymmetry Asy2 is obtained which corresponds to a reference recording laser power Po2 in the recording speed of 8× (step S403).

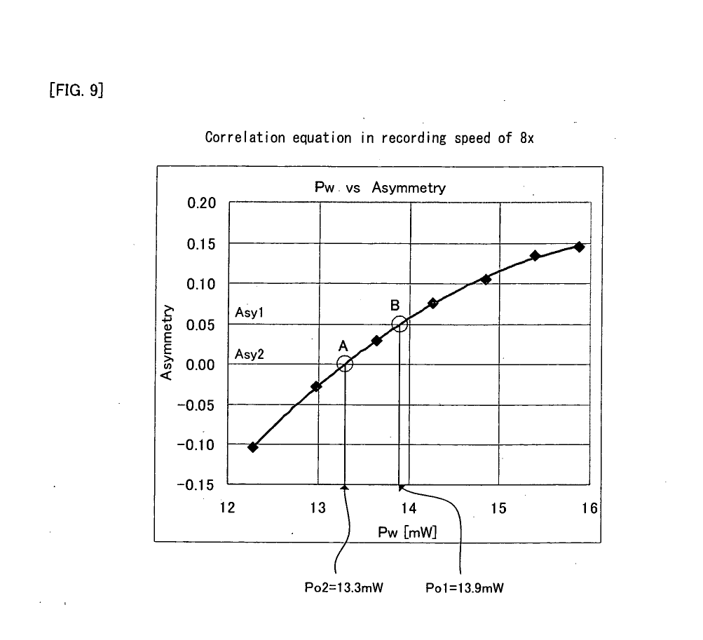

This operation will be discussed in more detail, with reference to FIG. 9. FIG. 9 is a graph conceptually showing a state on the correlation equation upon the adjustment of the recording laser power.

As shown in FIG. 9, it is assumed that there is the correlation equation in the recording speed of 8×. At this time, the recording laser power Po1 which realizes Asy1 is an intersection of the graph shown by the correlation equation and the line shown by Asy1. Moreover, the asymmetry Asy2 corresponding to the reference recording laser power Po2 is an intersection of the graph shown by the correlation equation and the line shown by the reference recording laser power Po2.

This will be specifically explained with numerical values. It is assumed that the asymmetry Asy1 obtained in the step S401 is “0.05”, and that the reference recording laser power Po2 is “13.3 mW”. In this case, the value of the recording laser power at the intersection of the graph in FIG. 9 and the linear line with Asy=0.05 is the recording laser power Po1. By this graph, it is obtained that Po1=13.9 mW. Moreover, the value of the asymmetry at the intersection the graph in FIG. 9 and the linear line with the recording laser power Po2=13.3 mW is the value of the asymmetry Asy2. By this graph, it is obtained that Asy2=0.

Incidentally, the asymmetry Asy2 corresponding to the reference laser power Po2 is the asymmetry value used in obtaining the reference laser power in the step S203 in FIG. 5. Therefore, the asymmetry Asy2 is not necessarily obtained in the step S403 in FIG. 8, and the asymmetry value used in the step S203 in FIG. 5 may be regarded as Asy2.

In FIG. 8 again, under the control of the CPU 400, a difference A Asy between the asymmetry obtained in the step S401 and the asymmetry obtained in the step S403 is obtained (step S404). In other words, the difference ΔAsy which is |Asy1-Asy2| is obtained. For example, as in the above-mentioned example, if Asy1=“0.05” and Asy2=“0”, ΔAsy=“0.05”. Then, under the control of the CPU 400, it is judged whether or not the difference ΔAsy is greater than a numerical value of “0.01” as being one specific example of the “predetermined amount” of the present invention (step S405).

Incidentally, without limit to the numerical value of “0.01” which is a judgment reference in the step S405, it is preferable to set a less value if the soft landing operation is set to being performed more strictly. On the other hand, it is preferable to set a greater value if the soft landing operation is set not to being performed much. The setting may be performed by a user of the information recording apparatus 1 with a remote controller, an operation button, or the like. Alternatively, the setting may be performed, automatically, by the CPU 400. Moreover, without limit to the judgment by the numerical values, an instruction of whether or not the soft landing operation is performed may be inputted by the user, for example.

As a result of the judgment, if it is judged that the difference is not grater than 0.01 (the step S405: No), the adjustment operation of the recording laser power is ended without the soft landing operation. Then, the operational flow goes to the step S304 in FIG. 7, and the data is recorded at the reference laser power Po2 in the recording speed of 8×. As described above, if the asymmetry Asy1 and the asymmetry Asy2 do not have greatly different values, an auto slicer described later can follow a change of the asymmetry, even if the data is not recorded by the soft landing operation. Therefore, it is possible to let the information reproducing apparatus, such as a player, appropriately reproduce the data.

On the other hand, if it is judged that the difference is grater than 0.01 (the step S405: Yes), an actual recording laser power Po at which the recording is actually performed is set to the recording laser power Po1 obtained in the step S402 (step S406). Specifically, by the operation of the LD driver 320 as being one specific example of the “adjusting device” of the present invention, the setting is performed such that the output of the semiconductor laser of the optical pickup 310 which irradiates the laser light is the recording laser power Po1.

Then, at the actual recording laser power Po set in the step S406, the data is recorded into a recording area corresponding to one sector (step S407).

Then, a recording laser power obtained by subtracting 0.1 mW from the actual recording laser power Po is set to a new actual recording laser power Po (step S408). Then, under the control of the CPU 400, it is judged whether or not the actual recording laser power Po (i.e. the actual recording laser power Po which is 0.1 mW smaller than the previous time) is less than the reference laser power Po2 (step S409).

As a result of the judgment, if it is judged that the actual recording laser power Po is not less than the reference laser power Po2 (the step S409: No), the data is recorded again into a recording area corresponding to one sector at the actual recording laser power Po which is 0.1 mW smaller, and the subsequent operation is repeated. At this time, the recording area corresponding to one sector to record therein the data is preferably a recording area adjacent to the previously recorded recording area. On the other hand, if it is judged that the actual recording laser power Po is less than the reference laser power Po2 (the step S409: Yes), the Po2 is updated as a new actual recording laser power Po, the operational flow goes to the step S304 in FIG. 7, and the subsequent recording operation is continued.

Incidentally, in FIG. 8, the case in which the recording laser power Po1 is greater than the reference recording laser power Po2 is assumed. Therefore, if the recording laser power Po1 is less than the reference recording laser power Po2, it is necessary that the recording laser power obtained by adding 0.1 mW to the Po is set as a new actual recording laser power Po in the step 408 and that the data is sequentially recorded. Then, in the judgment in the step S409, it is necessary to judge whether or not the actual recording laser power Po is greater than the reference recording laser power Po2.

Moreover, the numerical value of “0.01 mW” which is used for addition or subtraction, as occasion demands, in the step S408 (i.e. one specific example of the “predetermined adjustment amount” or the “predetermined change rate” in the present invention) may be changed, as occasion demands. For example, if the change of the recording laser power is set to be milder, it is preferable to set the numerical value to be smaller. On the other hand, even if the change of the recording laser power is rapid or sudden, if it is desired to reduce the number of times of the change steps, it is preferable to set the numerical value to be larger. Moreover, the numerical value of “one sector” which is the size of an area to record therein the data in the step S407 may be also changed, as occasion demands. For example, the recording may be performed in units of several sectors, or maybe performed in units of one or several ECC blocks. Alternatively, the recording may be performed in units of a predetermined size of recording area other than the above. Alternatively, the size of the area to record therein the data may be set by a time length required for the change of the recording laser power. For example, the recording laser power Po1 may be changed to the reference recording laser power Po2, in substantially one second. Then, such a change may be automatically performed by the operation of the CPU 400, for example, or may be performed on the basis of an instruction from the user with a remote controller, an operation button, or the like.

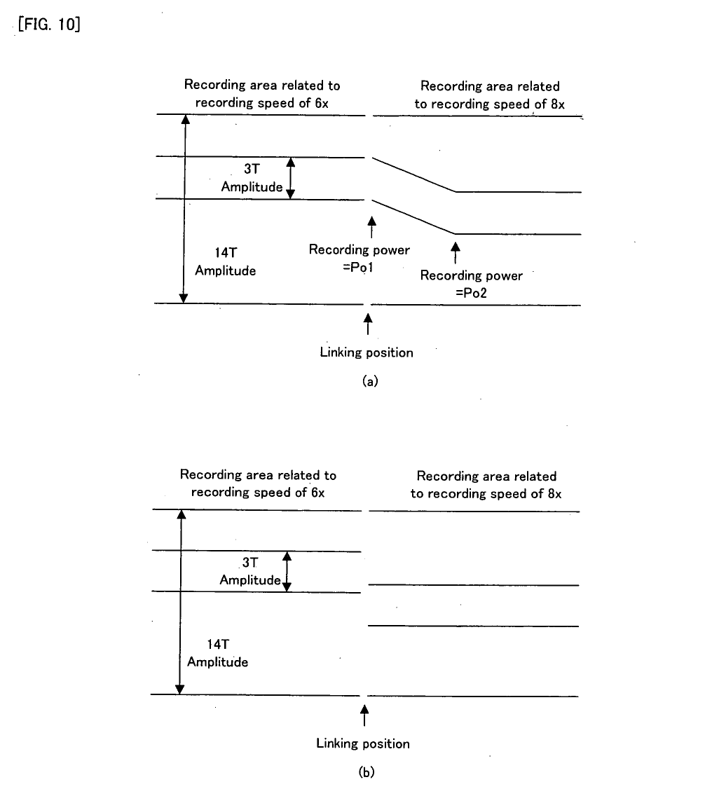

As described above, an explanation will be given to an aspect of the asymmetry of the data to be recorded, in the case in which the data is recorded by performing the soft landing operation at a point where the linear velocity is changed, with reference to FIGS. 10. FIGS. 10 are explanatory diagrams conceptually showing a state of the asymmetry before and after the change of the linear velocity and a state of the asymmetry in a comparison example.

As shown in FIG. 10(a), according to the information recording apparatus 1 in the example, the change in the asymmetry is mild in a 3 T amplitude pattern, between before the linear velocity changes (e.g. upon the recording in the recording speed of 6×) and after the linear velocity changes (e.g. upon the recording in the recording speed of 8×). In other words, across a linking position which is one boundary of the data recording and which corresponds to a point where the linear velocity changes, the asymmetry changes relatively mildly, without a rapid change in the asymmetry. Therefore, even if an auto slicer of the information reproducing apparatus has bad responsiveness, or even in the case of a data structure which adopts a lossless link or the like, the auto slicer can follow the change in the asymmetry, so that it is possible to appropriately reproduce the data.

Incidentally, the auto slicer is mainly to trace the data recorded on the optical disc 100 and to binalize a signal reproduced from the recording pit.

If the soft landing operation as in the example is not performed, as shown in FIG. 10(b), the asymmetry changes suddenly, across the linking position corresponding to the point where the linear velocity changes. Thus, if the auto slicer has the bad responsiveness or if an interval between the data and the data is relatively narrow as in the lossless link, the auto slicer cannot follow the change in the asymmetry, which causes such a disadvantage that the data cannot be appropriately reproduced (e.g. occurrence of a reading error, or the like).

However, the present invention has such great advantages that it is possible to effectively prevent the disadvantage by performing the soft landing operation and that it is possible to preferably record the data so as to enable the information reproducing apparatus to appropriately reproduce the data. Then, it has such a great advantage that it is possible to effectively prevent a reproduction error upon the reproduction of the recorded data, as compared to the recording apparatus disclosed in the above-mentioned background art document.

Moreover, the adjustment operation of the recording laser power including this soft landing operation is also performed on the basis of the correlation equation obtained in the OPC process. In other words, it is possible to appropriately adjust the recording laser power so as to change the asymmetry, more smoothly, by using the asymmetry of the actually recorded data and the correlation equation obtained in the OPC process. Incidentally, in the OPC process conventionally performed, if the value of the reference recording laser power is obtained, various data (i.e. the correlation equation or the like, for example) obtained in the process is eliminated or discarded. In the example, however, there is such a great advantage that the various data (particularly, the correlation equation) is used effectively, to thereby obtain the more preferable recording laser power corresponding to the recording characteristics or the like of the optical disc 100.

Incidentally, in the above-mentioned example, the recording speed of 6× and the recording speed of 8× are explained as a specific example; however, without limit to this, the same operation can be performed even in the recording speeds 1×, 2×, and 4× and other recording speeds. Moreover, in the above-mentioned example, as the specific example in which the linear velocity is changed, the case in which the recording speed of the optical disc 100 is changed is explained. However, even if the recording speed is the same but the linear velocity and the number of rotations of the spindle motor 301 or the like are changed, the above-mentioned operation may be performed. Moreover, without limit to the ZCLV recording with respect to the optical disc in the CLV method, even in the case of an optical disc in a CAV method, ZCLV method, or ZCAV method, the same operation may be performed if the linear velocity is changed. In any construction adopted, it is possible to receive the various benefits owned by the information recording apparatus 1 in the above-mentioned example.

Moreover, as described later, the recording laser power may be adjusted, as occasion demands, even during the data recording. For example, during the recording operation, the asymmetry of the recording area where the data is recorded may be measured, and the measured asymmetry may be compared to the originally desired asymmetry value, to thereby adjust the recording laser power, as occasion demands, to realize the desired asymmetry value. In this case, the recording laser power may be adjusted while performing the soft landing operation as described above, or the recording laser power may be adjusted without performing the soft landing operation. By this, it is possible to continue the more appropriate data recording, and it is also possible to improve the reproduction quality of the recorded data.

Moreover, in the example, the value of the asymmetry is used as one specific example of the “reproduction quality” of the present invention; however, without limit to this, the recording laser power may be adjusted on the basis of a jitter value, a reproduction error rate, degree of modulation, the reflectance of the laser light, or the like, for example. For example, the value of the recording laser power which allows the smallest jitter value may be obtained as the value of the reference recording laser power. Alternatively, the value of the recording laser power which allows the smallest reproduction error rate may be obtained as the value of the reference recording laser power. Then, these values may be combined, as occasion demands, to obtain the value of the recording laser power. Alternatively, out of the values, a high-priority value may be set in advance, to thereby obtain the value of the recording laser power.

Moreover, in the above-mentioned example, the optical disc 100 is explained as one example of the information recording medium, and the player related to the optical disc 100 is explained as one example of the information reproducing apparatus. The present invention, however, is not limited to the optical disc and the player thereof, and can be applied to other various information recording media and players thereof that support high-density recording or a high transfer rate.

The present invention is not limited to the above-described example, and various changes may be made, if desired, without departing from the essence or spirit of the invention which can be read from the claims and the entire specification. An information recording apparatus, an information recording method, and a computer program for recording control, all of which involve such changes, are also intended to be within the technical scope of the present invention.

### INDUSTRIAL APPLICABILITY

The information recording apparatus, the information recording method, and the computer program according to the present invention can be applied to a recorder associated with a high-density optical disc in which various information can be recorded at high density, for consumer use or for commercial use. Moreover, they can be applied to a recording apparatus or the like which is mounted on various computer equipment for consumer use or for commercial use, or which can be connected to various computer equipment.

1. An information recording apparatus comprising:
a recording device for recording record information onto an information recording medium, in which a recording speed can be changed to at least first and second linear velocities and which supports the first and second linear velocities, by irradiating laser light with a variable recording power;
a measuring device for measuring reproduction quality of the record information by reproducing the record information recorded at the first linear velocity, if the recording speed is changed from the first linear velocity to the second linear velocity;
a first calculating device for calculating a link power which is the recording power which gives the reproduction quality measured by said measuring device in the second linear velocity, on the basis of correlation information for representing a correlation between the recording power in the second linear velocity and the reproduction quality related to the record information; and
an adjusting device for adjusting the recording power, by a predetermined adjustment amount at a time in stages or in a predetermined change rate in continuity, such that the recording power changes from the link power to a reference power which is the recording power which gives desired target quality as the reproduction quality, if the recording speed is changed from the first linear velocity to the second linear velocity.

2. The information recording apparatus according to claim 1, wherein said measuring device measures the reproduction quality by reproducing the record information recorded immediately before the recording speed is changed from the first linear velocity to the second linear velocity.

3. The information recording apparatus according to claim 1, wherein the predetermined adjustment amount or the predetermined change rate is variable.

4. The information recording apparatus according to claim 1, wherein said adjusting device adjusts the recording power such that the recording power changes to the reference power if a difference between the link power and the reference power is equal to or less than a predetermined amount.

5. The information recording apparatus according to claim 1, further comprising a second calculating device for preparing the correlation information and for calculating the reference power, by reproducing test information which is the record information recorded for test by said recording device while the recording power is changed.

6. The information recording apparatus according to claim 1, wherein the reproduction quality includes at least one of an asymmetry value, a jitter value and a reproduction error rate.

7. The information recording apparatus according to claim 5, further comprising a controlling device for controlling said recording device to record at least one of the correlation information prepared by said second calculating device and information as for the reference power calculated by said second calculating device, onto said information recording medium.

8. An information recording method in an information recording apparatus comprising: a recording device of recording record information onto an information recording medium, in which a recording speed can be changed to at least first and second linear velocities and which supports the first and second linear velocities, by irradiating laser light with a variable recording power, said information recording method comprising:
a measuring process of measuring reproduction quality of the record information by reproducing the record information recorded at the first linear velocity, if the recording speed is changed from the first linear velocity to the second linear velocity;
a first calculating process of calculating a link power which is the recording power which gives the reproduction quality measured at said measuring process in the second linear velocity, on the basis of correlation information for representing a correlation between the recording power in the second linear velocity and the reproduction quality related to the record information; and
an adjusting process of adjusting the recording power, by a predetermined adjustment amount at a time in stages or in a predetermined change rate in continuity, such that the recording power changes from the link power to a reference power which is the recording power which gives desired target quality as the reproduction quality, if the recording speed is changed from the first linear velocity to the second linear velocity.

9. A computer program product for tangibly embodying a program of instructions executable by a computer provided in the information recording apparatus, to make the computer function as at least one portion of a first calculating device, a measuring device and an adjusting device,
said information recording apparatus comprising:
said recording device for recording record information onto an information recording medium, in which a recording speed can be changed to at least first and second linear velocities and which supports the first and second linear velocities, by irradiating laser light with a variable recording power;
said measuring device for measuring reproduction quality of the record information by reproducing the record information recorded at the first linear velocity, if the recording speed is changed from the first linear velocity to the second linear velocity;
said first calculating device for calculating a link power which is the recording power which gives the reproduction quality measured by said measuring device in the second linear velocity, on the basis of correlation information for representing a correlation between the recording power in the second linear velocity and the reproduction quality related to the record information; and
said adjusting device for adjusting the recording power, by a predetermined adjustment amount at a time in stages or in a predetermined change rate in continuity, such that the recording power changes from the link power to a reference power which is the recording power which gives desired target quality as the reproduction quality, if the recording speed is changed from the first linear velocity to the second linear velocity.
